(19) United States
(12) Patent Application Publication
(10) Pub. No.: US 2025/0380183 A1
(43) Pub. Date: Dec. 11, 2025

(54) QUALITY OF SERVICE SETUP FOR WIRELESS NETWORK

(71) Applicant: Samsung Electronics Co., Ltd., Suwon-si (KR)

(72) Inventors: Rubayet Shafin, Allen, TX (US); Boon Loong Ng, Plano, TX (US); Yue Qi, Plano, TX (US); Peshal Nayak, Plano, TX (US); Vishnu Vardhan Ratnam, Plano, TX (US)

(21) Appl. No.: 19/215,731

(22) Filed: May 22, 2025

Related U.S. Application Data
(60) Provisional application No. 63/656,939, filed on Jun. 6, 2024.
(60) Provisional application No. 63/660,852, filed on Jun. 17, 2024.
(60) Provisional application No. 63/684,153, filed on Aug. 16, 2024.

(51) Int. Cl. H04W 28/02; H04L 47/2408; H04W 84/12

(52) U.S. Cl. CPC H04W 28/0268; H04L 47/2408; H04W 84/12

(57) ABSTRACT

An access point (AP) for facilitating communication in a wireless network. The AP has a memory and a processor. The AP receives, from a station (STA), a request frame requesting dynamic stream classification service. The request frame includes a plurality of quality of service (QoS) profiles. Each QoS profile is associated with a respective QoS characteristics element indicating QoS expectation of traffic flow. The AP transmits, to the STA, a response frame accepting the request. The AP transmits, to the STA, one or more frames based on a first QoS profile among the plurality of QOS profiles. The AP receives, from the STA, a frame indicating a switch to a second QoS profile among the plurality of QoS profiles. The AP transmits, to the STA, one or more frames based on the second QoS profile in response to the frame indicating a switch to the second QoS profile.

### CROSS REFERENCE TO RELATED APPLICATION

This application claims benefit of U.S. Provisional Application No. 63/656,939, entitled “MULTI-AP COORDINATION,” filed on Jun. 6, 2024; U.S. Provisional Application No. 63/660,852, entitled “QOS SETUP PROCEDURES FOR NEXT GENERATION WLAN,” filed on Jun. 17, 2024; and U.S. Provisional Application No. 63/684,153, entitled “QOS SETUP PROCEDURES FOR NEXT GENERATION WLAN,” filed on Aug. 16, 2024, in the United States Patent and Trademark Office, all of which are hereby incorporated by reference in their entireties.

### TECHNICAL FIELD

This disclosure relates generally to a wireless communication system, and more particularly to, for example, but not limited to, quality of service setup operation in wireless networks.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHZ, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

This disclosure may be directed to improvements to a wireless communications system, more particularly to provide a mechanism and protocol for dynamically changing the quality of service (QOS) flow, QoS expectation, QoS setup, or QoS profile for a non-access point (AP) station (STA) with an AP or non-AP STA.

An aspect of the disclosure provides an AP for facilitating communication in a wireless network. The AP comprises a memory and a processor coupled to the memory. The processor is configured to cause receiving, from an STA, a first request frame requesting dynamic stream classification service. The first request frame includes a plurality of QOS profiles. Each QoS profile being associated with a respective QoS characteristics element indicating QoS expectation of traffic flow. The processor is further configured to cause transmitting, to the STA, a first response frame accepting the request for dynamic stream classification service. The processor is further configured to cause transmitting, to the STA, one or more frames based on a first QoS profile among the plurality of QoS profiles. The processor is further configured to cause receiving, from the STA, a frame indicating a switch to a second QoS profile among the plurality of QoS profiles. The processor is further configured to cause transmitting, to the STA, one or more frames based on the second QoS profile in response to the frame indicating a switch to the second QoS profile.

In an embodiment, the first response frame includes one or more QoS profiles. Each QoS profile is associated with a respective QoS characteristics element indicating QoS expectation of traffic flow.

In an embodiment, the processor is further configured to cause, prior to transmitting the one or more frames based on a first QoS profile, receiving, from the STA, a frame indicating activation of the first QoS profile.

In an embodiment, the first request frame indicates activation of the first QoS profile.

In an embodiment, the processor is further configured to cause receiving, from the STA, a second request frame requesting modification of one or more parameters of at least one QoS profile among the plurality of QoS profiles. The processor is further configured to cause transmitting, to the STA, a second response frame accepting modification of at least one parameter.

In an embodiment, the processor is further configured to cause receiving, from the STA, a second request frame requesting to amend a QoS profile by adding a QoS profile, deleting a QoS profile, or changing a QoS profile. The processor is further configured to cause transmitting, to the STA, a second response frame accepting the request to amend the QoS profile.

In an embodiment, the processor is further configured to cause receiving, from the STA, a second request frame requesting a modification of at least one parameter of the dynamic stream classification service based on a first parameter list. The process is further configured to cause transmitting, to the STA, a second response frame indicating an acceptance of the requested modification. The processor is further configured to cause changing the at least one parameter of the dynamic stream classification service based on the first parameter list.

In an embodiment, the processor is further configured to cause receiving, from the STA, a second request frame requesting a modification of at least one parameter of the dynamic stream classification service based on a first parameter list. The processor is further configured to cause transmitting, to the STA, a second response frame indicating a modification of at least one parameter of the dynamic stream classification service based on a second parameter list, wherein the second parameter list differs from the first parameter list. The processor is further configured to cause changing the at least one parameter of the dynamic stream classification service based on the second parameter list.

An aspect of the disclosure provides an STA for facilitating communication in a wireless network. The STA comprises a memory and a processor coupled to the memory. The processor configured to cause transmitting, to an AP, a first request frame requesting dynamic stream classification service. The first request frame includes a plurality of QoS profiles. Each QoS profile is associated with a respective QoS characteristics element indicating QOS expectation of traffic flow. The processor is further configured to cause receiving, from the AP, a first response frame accepting the request for dynamic stream classification service. The processor is further configured to cause receiving, from the AP, one or more frames based on a first QoS profile among the plurality of QOS profiles. The processor is further configured to cause transmitting, to the AP, a frame indicating a switch to a second QoS profile among the plurality of QoS profiles. The process is further configured to cause receiving, from the AP, one or more frames based on the second QoS profile.

In an embodiment, the first response frame includes one or more QoS profiles. Each QoS profile is associated with a respective QoS characteristics element indicating QoS expectation of traffic flow.

In an embodiment, the processor is further configured to cause, prior to receiving the one or more frames based on a first QoS profile, transmitting, to the AP, a frame indicating activation of the first QoS profile.

In an embodiment, the first request frame indicates activation of the first QoS profile.

In an embodiment, the processor is further configured to cause transmitting, to the AP, a second request frame requesting modification of one or more parameters of at least one QoS profile among the plurality of QOS profiles. The processor is further configured to cause receiving, from the AP, a second response frame accepting the modification of at least one parameter.

In an embodiment, the processor is further configured to cause transmitting, to the AP, a second request frame requesting to amend a QoS profile by adding a QoS profile, deleting a QoS profile, or changing a QoS profile. The processor is further configured to cause receiving, from the AP, a second response frame accepting the request to amend the QoS profile.

In an embodiment, the processor is further configured to cause transmitting, to the AP, a second request frame requesting a modification of at least one parameter of the dynamic stream classification service based on a first parameter list. The processor is further configured to cause receiving, from the AP, a second response frame indicating an acceptance of the requested modification.

In an embodiment, the processor is further configured to cause transmitting, to the AP, a second request frame requesting a modification of at least one parameter of the dynamic stream classification service based on a first parameter list. The processor is further configured to cause receiving, from the AP, a second response frame indicating a modification of at least one parameter of the dynamic stream classification service based on a second parameter list, wherein the second parameter list differs from the first parameter list.

An aspect of the disclosure provides a method performed by an AP. The method comprises receiving, from an STA, a first request frame requesting dynamic stream classification service. The first request frame including a plurality of QoS profiles. Each QoS profile is associated with a respective QOS characteristics element indicating QOS expectation of traffic flow. The method further comprises transmitting, to the STA, a first response frame accepting the request for dynamic stream classification service. The method further comprises transmitting, to the STA, one or more frames based on a first QoS profile among the plurality of QoS profiles. The method further comprises receiving, from the STA, a frame indicating a switch to a second QoS profile among the plurality of QoS profiles. The method further comprises transmitting, to the STA, one or more frames based on the second QoS profile in response to the frame indicating a switch to the second QoS profile.

In an embodiment, the first response frame includes one or more QoS profiles. Each QoS profile is associated with a respective QOS characteristics element indicating QoS expectation of traffic flow.

In an embodiment, the method further comprises, prior to transmitting the one or more frames based on a first QoS profile, receiving, from the STA, a frame indicating activation of the first QoS profile.

In an embodiment, the method further comprises receiving, from the STA, a second request frame requesting modification of one or more parameters of at least one QoS profile among the plurality of QOS profiles. The method further comprises transmitting, to the STA, a second response frame accepting the modification of at least one parameter.

### BRIEF DESCRIPTION OF THE DRAWINGS

FIG. 1 illustrates an example of a wireless network in accordance with an embodiment of this disclosure.

FIG. 2A shows an example of AP in accordance with an embodiment.

FIG. 2B shows an example of STA in accordance with an embodiment.

FIG. 3 shows an example of multi-link communication operation in accordance with an embodiment.

FIG. 4 shows an example network in accordance with an embodiment.

FIG. 5 shows an example D-SCS request frame format in accordance with an embodiment.

FIG. 6 shows an example D-SCS response frame format in accordance with an embodiment.

FIG. 7 shows an example descriptor element format of a request frame or a response frame in accordance with an embodiment.

FIG. 8 shows an example of dynamic switching between QoS profiles in accordance with an embodiment.

FIG. 9 shows an example QoS negotiation in accordance with an embodiment.

FIG. 10 shows another example QoS negotiation in accordance with an embodiment.

FIG. 11 shows another example QoS negotiation in accordance with an embodiment.

FIG. 12 shows an example QOS renegotiation in accordance with an embodiment.

FIG. 13 shows another example QOS renegotiation in accordance with an embodiment.

FIG. 14 shows another example QOS renegotiation in accordance with an embodiment.

FIG. 15 shows another example QOS renegotiation in accordance with an embodiment.

FIG. 16 shows an example SCS parameter set change request in accordance with an embodiment.

FIG. 17 shows another example SCS parameter set change request in accordance with an embodiment.

FIG. 18 shows an example of MAP coordination in accordance with an embodiment.

FIG. 19 shows an example need for MAP coordination in accordance with an embodiment.

FIG. 20 shows an example CTDMA negotiation in accordance with an embodiment.

FIG. 21 shows an example MAP TWT SP based on CTDMA negotiation in accordance with an embodiment.

FIG. 22 shows an example TXOP sharing during MAP TWT SP in accordance with an embodiment.

FIG. 23 shows an example process establishing a QoS setup in accordance with an embodiment.

FIG. 24 shows another example process establishing a QoS setup in accordance with an embodiment.

FIG. 25 shows an example process establishing MAP CTDMA in accordance with an embodiment.

FIG. 26 shows another example process establishing MAP CTDMA in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The present disclosure relates to a wireless communication system, and more particularly, to a Wireless Local Area Network (WLAN) technology. WLAN allows devices to access the internet in the 2.4 GHZ, 5 GHZ, 6 GHz or 60 GHz frequency bands. WLANs are based on the Institute of Electrical and Electronic Engineers (IEEE) 802.11 standards. IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax etc.

Before undertaking the detailed description below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A, B, and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

Figures discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged system or device.

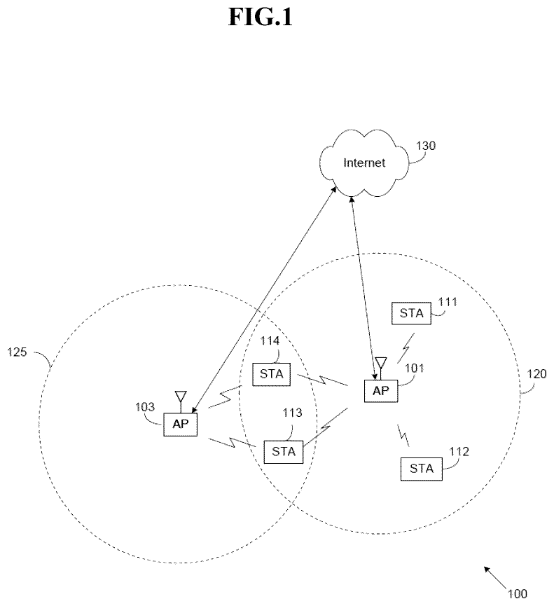

FIG. 1 shows an example wireless network 100 according to this disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using WiFi or other WLAN communication techniques.

Depending on the network type, other well-known terms may be used instead of “access point” or “AP,” such as “router” or “gateway.” For the sake of convenience, the term “AP” is used in this patent document to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this patent document to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for management of multiple user (MU)-MIMO and orthogonal frequency division multiple access (OFDMA) channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

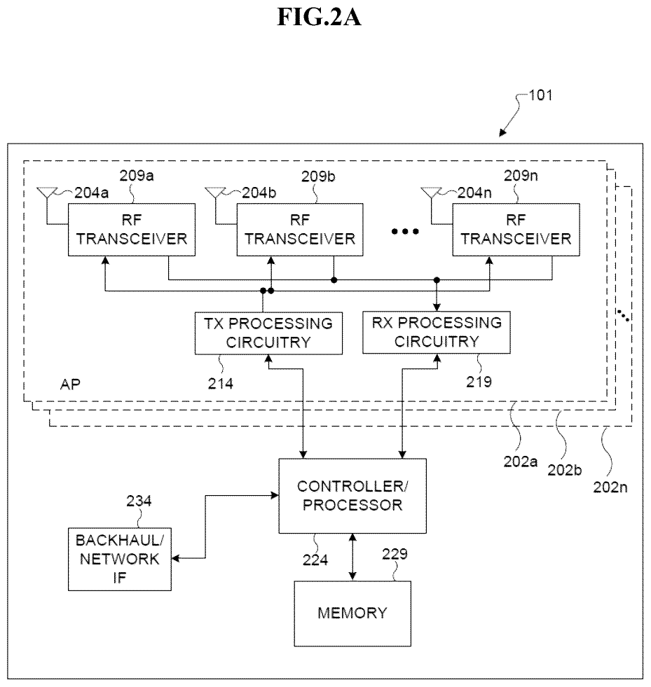

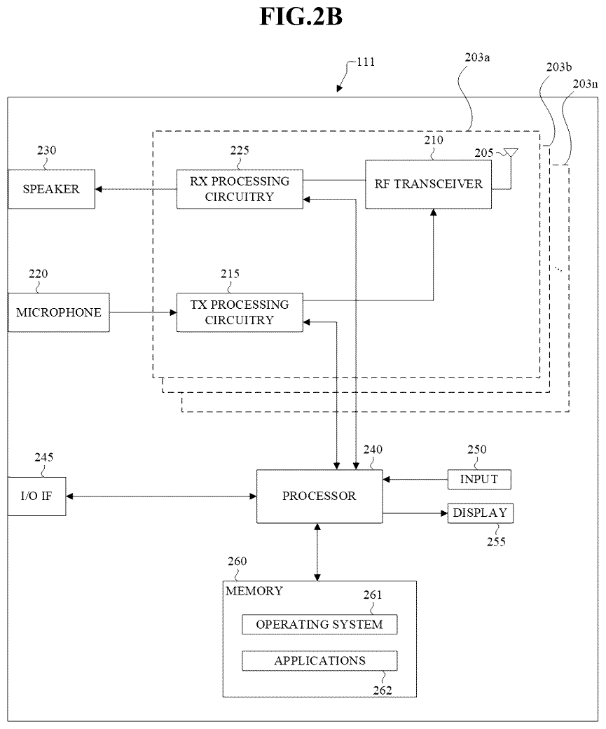

FIG. 2A shows an example AP 101 according to this disclosure. The embodiment of the AP 101 illustrated in FIG. 2A is for illustration only, and the AP 103 of FIG. 1 could have the same or similar configuration. However, APs come in a wide variety of configurations, and FIG. 2A does not limit the scope of this disclosure to any particular implementation of an AP.

As shown in FIG. 2A, the AP 101 includes multiple antennas 204a-204n, multiple RF transceivers 209a-209n, transmit (TX) processing circuitry 214, and receive (RX) processing circuitry 219. The AP 101 also includes a controller/processor 224, a memory 229, and a backhaul or network interface 234. The radio frequency (RF) transceivers 209a-209n receive, from the antennas 204a-204n, incoming RF signals, such as signals transmitted by STAs in the network 100. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or intermediate frequency (IF) signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions.

For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of downlink (DL) MU-MIMO and OFDMA in the same transmit opportunity. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A shows one example of AP 101, various changes may be made to FIG. 2A. For example, the AP 101 could include any number of each component shown in FIG. 2A. As a particular example, an access point could include a number of interfaces 234, and the controller/processor 224 could support routing functions to route data between different network addresses. As another particular example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiments, the AP 101 may be an AP MLD that includes multiple APs 202a-202n. Each AP 202a-202n is affiliated with the AP MLD 101 and includes multiple antennas 204a-204n, multiple RF transceivers 209a-209n, TX processing circuitry 214, and RX processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and lower media access control (MAC) layer.

FIG. 2B shows an example STA 111 according to this disclosure. The embodiment of the STA 111 illustrated in FIG. 2B is for illustration only, and the STAs 111-115 of FIG. 1 could have the same or similar configuration. However, STAs come in a wide variety of configurations, and FIG. 2B does not limit the scope of this disclosure to any particular implementation of a STA.

As shown in FIG. 2B, the STA 111 includes antenna(s) 205, a RF transceiver 210, TX processing circuitry 215, a microphone 220, and RX processing circuitry 225. The STA 111 also includes a speaker 230, a controller/processor 240, an input/output (I/O) interface (IF) 245, a touchscreen 250, a display 255, and a memory 260. The memory 260 includes an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the main controller/processor 240 controls the reception of forward channel signals and the transmission of reverse channel signals by the RF transceiver 210, the RX processing circuitry 225, and the TX processing circuitry 215 in accordance with well-known principles. The main controller/processor 240 can also include processing circuitry configured to provide management of channel sounding procedures in WLANs. In some embodiments, the controller/processor 240 includes at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The main controller/processor 240 is also coupled to the I/O interface 245, which provides STA 111 with the ability to connect to other devices such as laptop computers and handheld computers. The I/O interface 245 is the communication path between these accessories and the main controller 240.

The controller/processor 240 is also coupled to the touchscreen 250 and the display 255. The operator of the STA 111 can use the touchscreen 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a RAM, and another part of the memory 260 could include a Flash memory or other ROM.

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B shows the STA 111 configured as a mobile telephone or smartphone, STAs could be configured to operate as other types of mobile or stationary devices.

As shown in FIG. 2B, in some embodiments, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a PHY layer and a lower MAC layer.

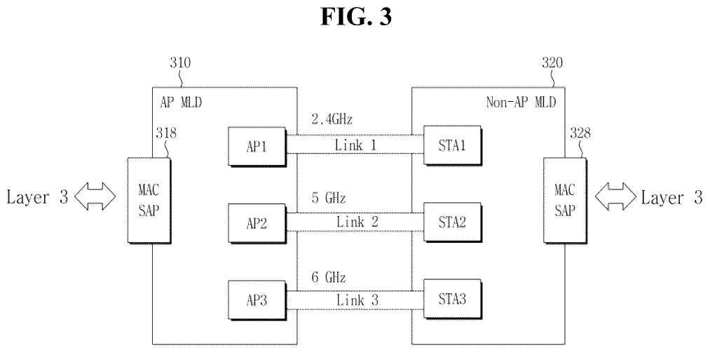

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHz band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021, “Wireless LAN Medium Access Control (MAC) and Physical Layer (PHY) Specifications,” and iii) IEEE P802.11be/D4.0, “Wireless LAN Medium Access Control (MAC) and Physical Layer (PHY) Specifications.”

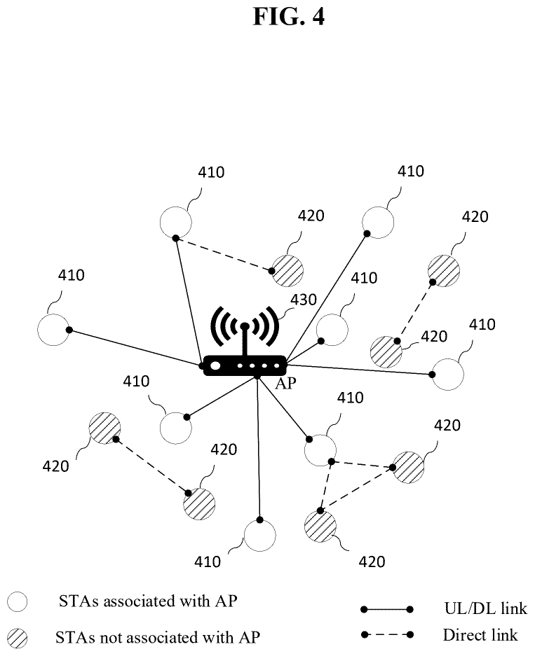

FIG. 4 shows an example network in accordance with an embodiment. The network depicted in FIG. 4 is for explanatory and illustration purposes. FIG. 4 does not limit the scope of this disclosure to any particular implementation.

In FIG. 4, a plurality of STAs 410 may be non-AP STAs associated with AP 430, and a plurality of STAs 420 may be non-AP STAs which are not associated with AP 430. Additionally, solid lines between STAs represent uplink or downlink with AP 430, while the dashed lines between STAs represent a direct link between STAs.

Next generation WLAN system needs to provide improved support for low-latency applications. Today, it is common to observe numerous devices operating on the same network as shown in FIG. 4. Many of these devices may have a tolerance for latency, but still compete with the devices running low-latency applications for the same time and frequency resources. In some cases, the AP 430 as a network controller may not have enough control over the unregulated or unmanaged traffic that contends with the low-latency traffic within the infrastructure basic service set (BSS). In some embodiments, the infrastructure BSS is a basic service set that includes an AP 430 and one or more non-AP STAs 410, while the independent BSS is a basic service set where non-AP STAs 420 communicate with each other without the need for a centralized AP. Some of the unregulated or unmanaged traffic that interferes with the latency-sensitive traffic in the BSS of the AP may originate from uplink, downlink, or direct link communications within the infrastructure BSS that the AP manages. Another source of the interference may be transmission from the neighboring infrastructure OBSS (Overlapping Basic Service Set), while others may come from neighboring independent BSS or peer to peer (P2P) networks. Therefore, the next generation WLAN system needs mechanisms to more effectively handle unmanaged traffic while prioritizing low-latency traffic in the network.

In the IEEE 802.11be specification, stream classification service (SCS) procedure was enhanced and a new element, the QoS (quality of service) characteristics element, was introduced, which can be included in an SCS Request frame and an SCS Response frame. The non-AP STA transmits, to the AP, an SCS request frame with a QoS characteristics element, indicating the non-AP STA's traffic flow characteristics. The AP receives, from the non-AP STA, the SCS request frame indicating the non-AP STA's traffic flow and determines to accept the SCS request. The AP transmits, to the non-AP STA, an SCS response frame indicating that the AP accepts the SCS request. After accepting the SCS request, the AP provisions resources to the non-AP STA based on the traffic characteristics described in the QoS Characteristics element included in the SCS request.

The SCS with QoS Characteristics procedure defined in IEEE 802.11be is for Quasi-static traffic flow, i.e., a traffic flow where the underlying assumption is that traffic characteristics of the traffic flow do not change too frequently. However, there are many scenarios where the users' traffic patterns change too frequently. An example includes during a Webex, Zoom or other video or live content sharing application where the codec rate can change dynamically and traffic characteristics can change based on the changes in the codec rate. Another example is various XR applications where the pose data from the hand-held device often needs to be transmitted to either a head-mounted device (HMD) or to a companion device in a very short time (highly latency sensitive) in order to ensure a smooth XR experience. Serving such latency sensitive applications requires a fast/dynamic change in the QoS characteristics between the hand-held device and the HMD or the companion device.

Currently, there is no mechanism defined in the 802.11 specification that would allow for a non-AP STA to dynamically change QoS expectation or QoS flow with the associated AP which may result in disruption of latency sensitive applications for clients.

This disclosure provides mechanisms and protocols for dynamically changing the QoS flow or QoS expectation or QoS setup or QoS profile for a non-AP STA with the AP or with another non-AP STA.

In an embodiment, a first STA (an AP STA or a non-AP STA) can set up a QoS flow of certain QoS characteristics with a second STA (an AP STA or a non-AP STA), where the certain QoS characteristics can change dynamically. In an embodiment, a ‘dynamic change’ in the QoS flow (or QoS setup) can be interpreted as a fast change in the QOS characteristics of the traffic or an unpredictable change in the QOS characteristics of the traffic.

In an embodiment, a new mode of SCS procedure is defined where a QoS flow can dynamically change. Such a mode of SCS procedure can be referred to as a Dynamic SCS (D-SCS). In an embodiment, if a first STA transmits to a second STA an SCS request corresponding to a D-SCS flow (a D-SCS request frame) that the first STA has established with the second STA, then the second STA can accept the request. The second STA can transmit an SCS response frame to the first STA indicating acceptance of the SCS request (e.g., by setting up Status field of SCS Status Duple field of an SCS Status List field of the SCS response frame to SUCCESS (Status code=0)). In an embodiment, the second STA can transmit to the first STA an acknowledgement frame in response to receiving the D-SCS request frame. The second STA transmitting the acknowledgement frame indicates that the second STA accepts the D-SCS request of the first STA.

In an embodiment, the first STA can be a non-AP STA, and the second STA can be an AP. In an embodiment, the first STA can be an AP, and the second STA can be a non-AP STA. In an embodiment, both the first STA and the second STA can be non-AP STAs. In an embodiment, both the first STA and the second STA can be APs.

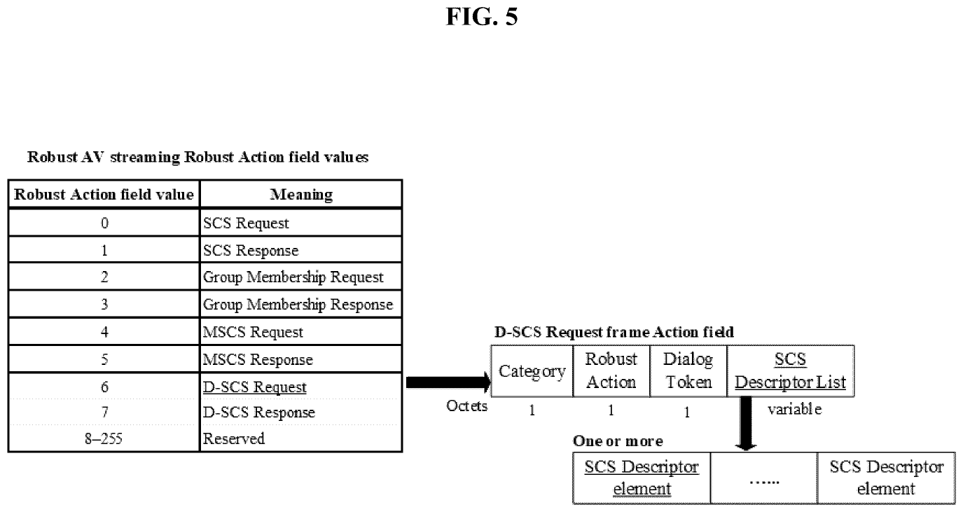

In an embodiment, when a first STA transmits to the second STA an SCS request frame, the first STA can indicate whether or not the SCS request is of D-SCS mode of SCS. For example, a Robust audio video (AV) Streaming Robust Action field can include new values for D-SCS request frames and D-SCS response frames which can be otherwise similar to SCS request frames and SCS response frames, as shown in FIG. 5.

FIG. 5 shows an example D-SCS Request frame format in accordance with an embodiment. The example depicted in FIG. 5 is for explanatory and illustration purposes. FIG. 5 does not limit the scope of this disclosure to any particular implementation.

Referring to FIG. 5, a D-SCS Request frame includes a Category field, a Robust Action field, a Dialog Token and an SCS Descriptor List. The Category field, Robust Action field and Dialog Token are each of a size of 1 Octets. The SCS Descriptor List is of variable size.

The Category field indicates the type of Action frame is a Robust AV stream Action frame.

The Robust Action field indicates the type of Robust AV streaming Action frame. As shown in FIG. 5, a value of ‘6’ in this field indicates that this Action frame is the D-SCS Request frame.

The Dialog Token field indicates matching action responses with action requests when there are multiple concurrent action requests.

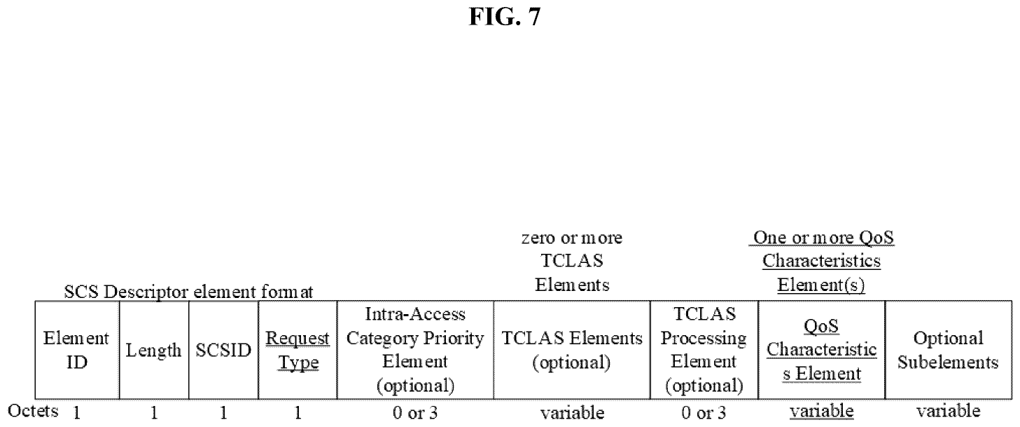

The SCS Descriptor includes one or more SCS Descriptor elements. An SCS Descriptor element includes information describing the SCS, as described below in FIG. 7.

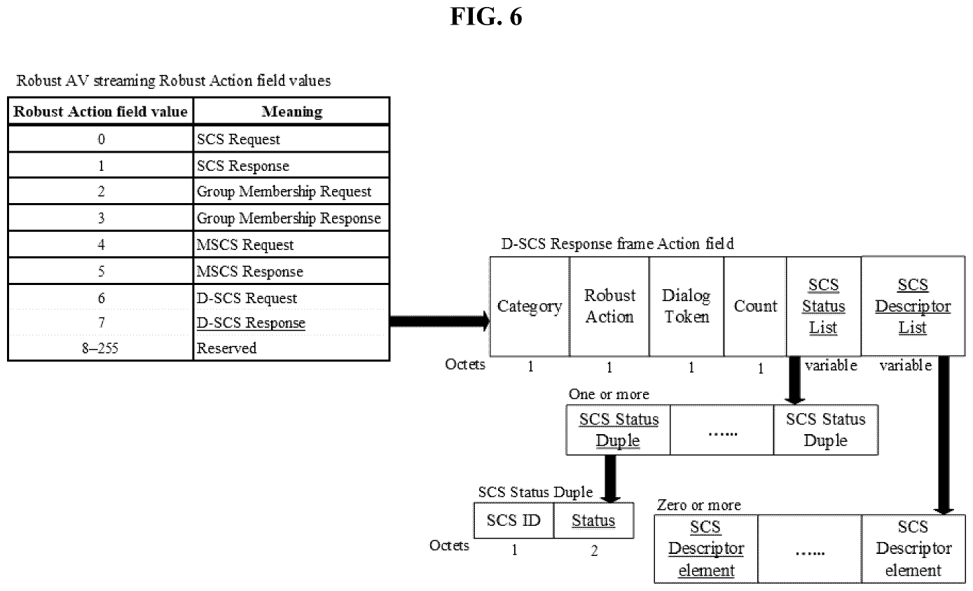

FIG. 6 shows an example D-SCS response frame format in accordance with an embodiment. The example depicted in FIG. 6 is for explanatory and illustration purposes. FIG. 6 does not limit the scope of this disclosure to any particular implementation.

Referring to FIG. 6, a D-SCS Response frame Action field includes a Category field, a Robust Action field, a Dialog Token, a Count field, an SCS Status list field and an SCS Descriptor List. The Category field, the Robust Action field, the Dialog Token field and the Count field are each 1 Octets in size. The SCS Status list and the SCS Descriptor List are of variable size.

The Category field indicates the type of Action frame is a Robust AV stream Action frame.

The Robust Action field indicates the type of Robust AV streaming Action frame. As shown in FIG. 6, a value of ‘7’ in this field indicates that this Action frame is the D-SCS Response frame.

The Dialog Token field indicates matching action responses with action requests when there are multiple concurrent action requests.

The Count field indicates the number of SCS Status duples in the SCS Status List field.

The SCS Status List includes one or more Status Duple. A Status Duple includes an SCS ID field and a Status field. The SCS ID field identifies the SCS stream. The Status field indicates whether or not the response is an acceptance of the corresponding request (the request indicated in the Dialog Token).

The SCS Descriptor includes zero or more SCS Descriptor elements. An SCS Descriptor element includes information describing the SCS, as described below.

In an embodiment, a D-SCS Request frame can include SCS requests for multiple SCS setups. Each SCS setup can be described in a respective SCS Descriptor element of the SCS Descriptor List of the D-SCS Request frame. In an embodiment, an SCS Descriptor element can include one or more QoS Characteristics elements. Each QoS Characteristics element can represent a respective QoS profile within the SCS Descriptor element within the D-SCS request. A QoS profile includes characteristics information corresponding to SCS traffic.

In an embodiment, a D-SCS Response frame can include SCS responses for one or more SCS setups. Each SCS setup can be described in a respective SCS Descriptor element of the SCS Descriptor List of the D-SCS Response frame. In an embodiment, the SCS Descriptor element can include one or more QoS Characteristics elements. Each QoS Characteristic element can represent a respective QoS profile within the SCS Descriptor element within the D-SCS response. A possible format of the SCS Descriptor element within the D-SCS Request and the D-SCS Response frames is shown in FIG. 7.

FIG. 7 shows an example descriptor element format of a request frame or a response frame in accordance with an embodiment. The example depicted in FIG. 7 is for explanatory and illustration purposes. FIG. 7 does not limit the scope of this disclosure to any particular implementation.

Referring to FIG. 7, an SCS Descriptor element format includes an Element ID field, a Length field, an SCSID field, a Request Type field, an Intra-Access Category Priority Element field (optional), a Traffic Classification (TCLAS) Elements field (optional), a TCLAS Processing Element field (optional), a QoS Characteristics Element field, and an Optional Subelements field.

The Element ID field includes information to identify the SCS descriptor element.

The Length field indicates a length of the SCS Descriptor element.

The SCSID field identifies the SCS stream specified in the SCS Descriptor element.

The Request Type field identifies the type of SCS request (e.g., ADD, Remove, Change).

The Intra-Access Category Priority Element field provides information from a non-AP STA to an AP on the relative priorities of streams within an access category.

The TCLAS Elements field indicates the number of incoming MSDUs that belong to the SCS stream.

The TCLAS Processing Element field indicates how TCLAS elements are to be processed when one or more TCLAS elements are present in the TCLAS Elements field.

The QoS Characteristics Element field includes one or more QoS Characteristics elements. Each QOS characteristics element describes the traffic characteristics and QoS expectations of a respective traffic flow that belongs to the SCS.

The Optional Subelements field includes one or more subelements that have a common general format.

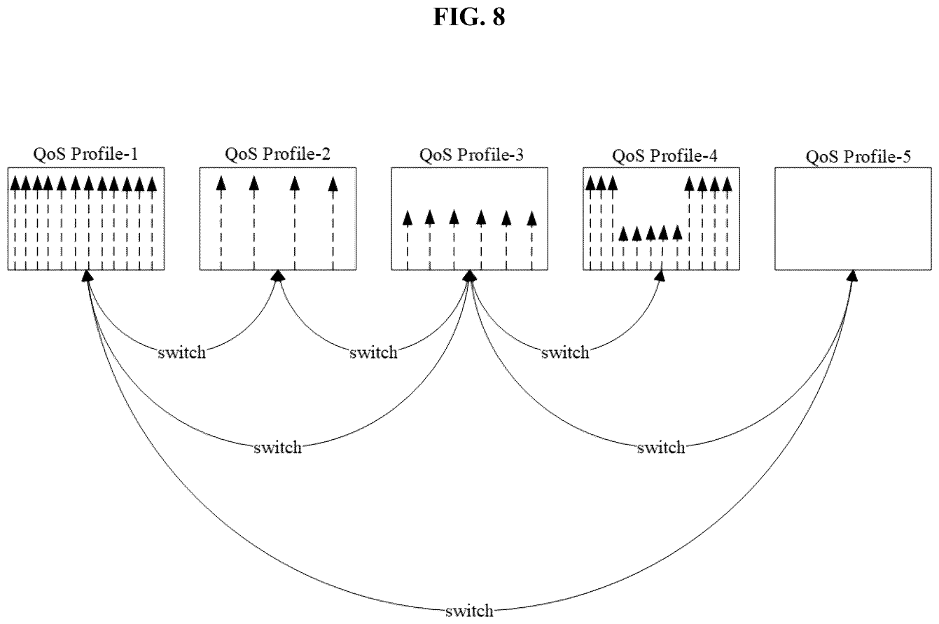

In an embodiment, if a first STA transmits to a second STA a D-SCS request frame including X number of SCS or QoS profiles corresponding to the request and the second STA accepts the D-SCS request, then the acceptance indicates that the first STA can request to dynamically switch from one QoS profile to another QoS profile within the set of QoS profiles included in the D-SCS request. Each QoS profile can correspond to a respective QoS Characteristics element within the SCS Descriptor element. The first STA can be a non-AP STA and the second STA can be an AP, as shown in FIG. 8.

FIG. 8 shows an example of dynamic switching between QoS profiles in accordance with an embodiment. The example depicted in FIG. 8 is for explanatory and illustration purposes. FIG. 8 does not limit the scope of this disclosure to any particular implementation.

Referring to FIG. 8, an STA and an AP have established D-SCS with five QoS profiles corresponding to the D-SCS: QoS Profile-1, QoS Profile-2, QoS Profile-3, QoS Profile-4, and QoS Profile-5. The STA can transmit to the AP a request to change QoS profiles and the AP can provision sufficient resources to the STA to satisfy the QOS requirements of the new QoS profile. For example, the STA in QoS Profile 1 of D-SCS can request to switch to QoS Profile 3 of D-SCS and the AP, in response, provision sufficient resources to the STA for the QOS requirements of QoS Profile-3. QoS Profile-1 indicates requirements associated with a high frequency of lengthy data transmissions. QoS Profile-2 indicates requirements associated with a low frequency of lengthy data transmissions. QoS Profile-3 indicates requirements associated with an average frequency of short data transmissions. QoS Profile-4 indicates requirements associated with a high frequency of some lengthy data transmissions and some short data transmissions. QoS Profile-5 indicates requirements associated with no data transmissions. In reference to the QOS Profiles, the higher frequency of data transmissions and the lengthier the data transmission, the more demanding the QoS requirements will be.

In an embodiment, if a first STA transmits to a second STA a D-SCS request frame including X number of SCS or QoS profiles corresponding to the request and the second STA accepts the D-SCS request, then the second STA can provision sufficient resources to the first STA so that the QoS requirement indicated by the most recent QoS profile indication is fulfilled. For example, if the second STA is an AP, then the second STA can trigger the first STA sufficient according to the most recently indicated QoS profile indicate by the first STA.

In an embodiment, after a first STA and a second STA have successfully setup D-SCS including QoS profiles, the first STA can transmit to the second STA a QoS Activation Request (QARq) frame that would indicate the QoS profile that the first STA requests to activate. In response, the second STA can transmit a QoS Activation Response (QARs) frame to indicate acceptance of the request. The second STA may be an AP.

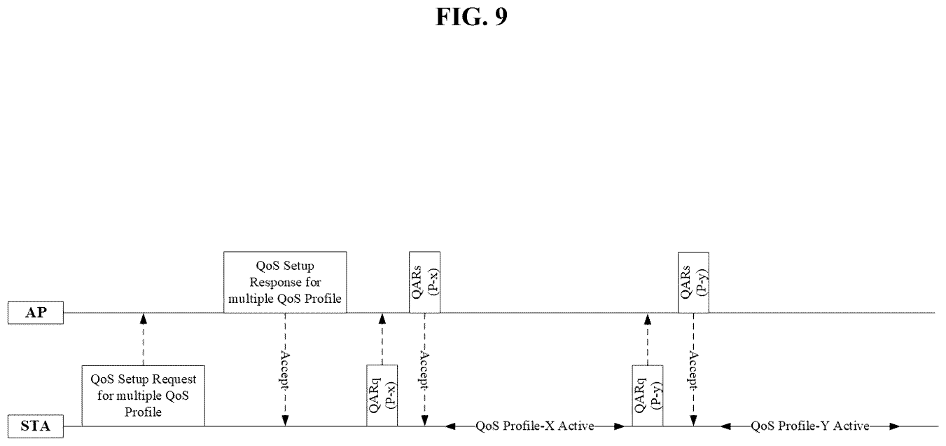

FIG. 9 shows an example QoS negotiation in accordance with an embodiment. The negotiation depicted in FIG. 9 is for explanatory and illustration purposes. FIG. 9 does not limit the scope of this disclosure to any particular implementation.

Referring to FIG. 9, an STA and an AP require D-SCS. The STA transmits, to the AP, a QoS Setup Request frame for multiple QoS profiles. In response, the AP transmits, to the STA, a QoS Setup Response frame for multiple QoS profiles accepting the QoS Setup request. Subsequently, the STA transmits, to the AP, a QARq (P-x) frame requesting activation of QoS Profile-x. In response, the AP transmits, to the STA, a QARs (P-x) frame accepting the request and activating QoS Profile-x. Subsequently, the STA transmits, to the AP, a QARq (P-y) frame requesting activation of QoS Profile-y. In response, the AP transmits, to the STA, a QARs (P-y) frame accepting the request and activating QoS Profile-y.

In an embodiment, after a first STA and a second STA have successfully setup D-SCS including QoS profiles, the first STA can transmit to the second STA a QoS Profile Indication (QPI) frame that would indicate the QoS profile that the first STA requests to activate. In response, the second STA can transmit an Acknowledgement (Ack) frame to the first STA. Subsequently, the second STA can activate the QoS profile indicated in the QPI frame.

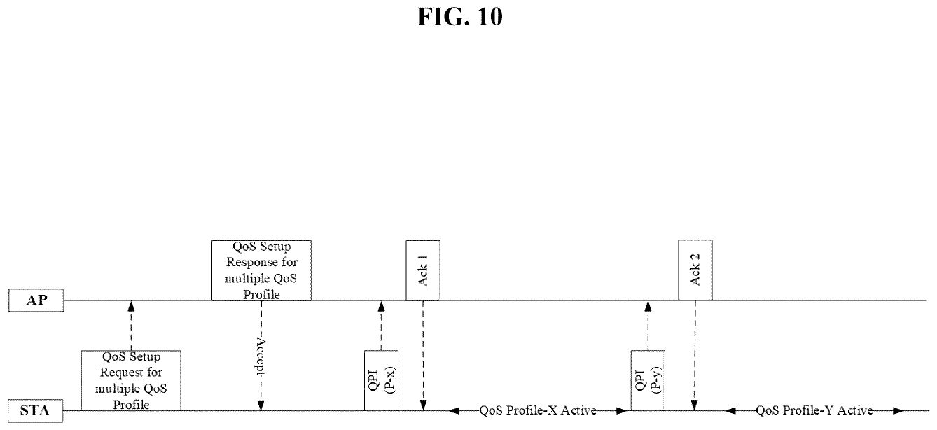

FIG. 10 shows another example QoS negotiation in accordance with an embodiment. The negotiation depicted in FIG. 10 is for explanatory and illustration purposes. FIG. 10 does not limit the scope of this disclosure to any particular implementation.

Referring to FIG. 10, an STA and an AP require D-SCS. The STA transmits, to the AP, QoS Setup Request frame for multiple QoS profiles. In response, the AP transmits, to the STA, a QoS Setup Response frame for multiple QoS profiles. Subsequently, the STA transmits, to the AP, a QPI frame requesting activation of QoS Profile-x. In response, the AP transmits, to the STA, an Ack 1 frame acknowledging the QPI frame for QoS Profile x and the AP activates the QoS Profile-x. Subsequently, the STA transmits, to the AP, a QPI frame requesting the activation of QoS Profile-y. In response, the AP transmits, to the STA, an Ack 2 frame acknowledging the QPI frame for QoS Profile-y and the AP activates the QoS Profile-y.

In an embodiment, a first STA can indicate which QoS profile to activate immediately after successful negotiation of a D-SCS request/response in the D-SCS request/response negotiation with a second STA. This activated QoS profile will remain active until the first STA transmits a subsequent QPI or QARq that indicates a different QoS profile.

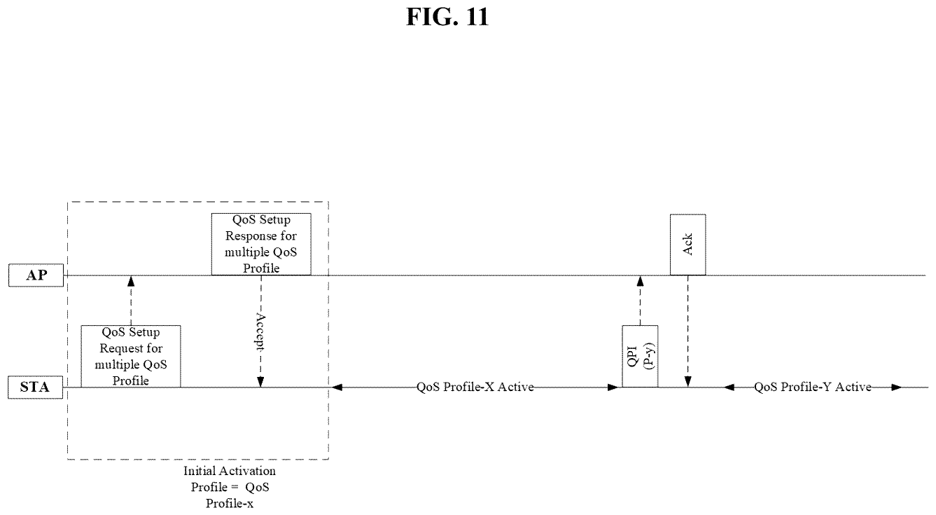

FIG. 11 shows another example QoS negotiation in accordance with an embodiment. The negotiation depicted in FIG. 11 is for explanatory and illustration purposes. FIG. 11 does not limit the scope of this disclosure to any particular implementation.

Referring to FIG. 11, an STA and an AP require D-SCS. The STA transmits, to the AP, QoS Setup Request frame for multiple QOS profiles including an indication for activation of QoS Profile-x. In response, the AP transmits, to the STA, a QoS Setup Response for multiple QoS profiles and the AP activates the QoS Profile-x. Subsequently, the STA transmits, to the AP, a QPI frame requesting activation of QoS Profile-y. In response, the AP transmits, to the STA, an Ack frame acknowledging the QPI frame for QoS Profile-y and the AP activates the QoS Profile-y.

In an embodiment, a first STA or a second STA that have setup a D-SCS with each other can transmit to the other STA another D-SCS Request frame to change any parameters of any QoS Profile of the Dynamic SCS request. The transmission of the another D-SCS Request frame initiates negotiation for the new QoS parameters for any of the QoS profiles.

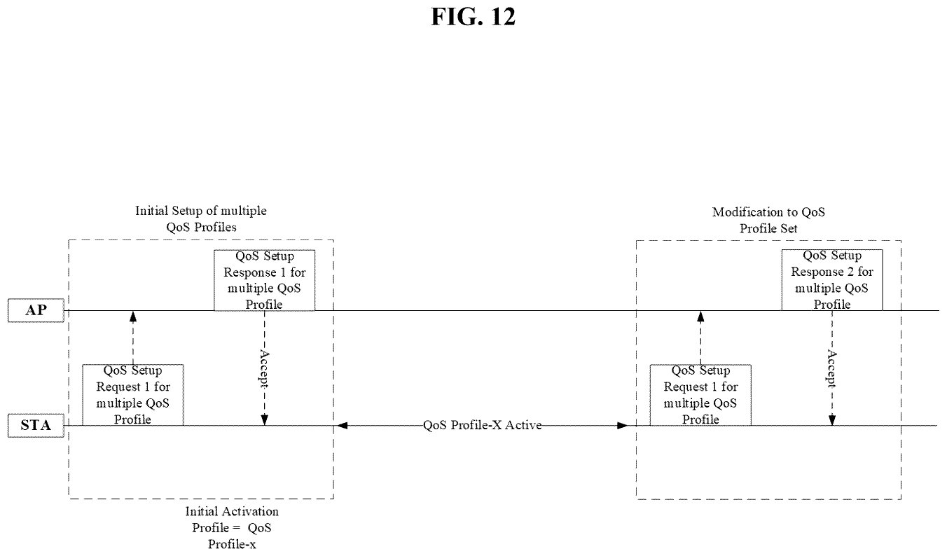

FIG. 12 shows an example QOS renegotiation in accordance with an embodiment. The renegotiation depicted in FIG. 12 is for explanatory and illustration purposes. FIG. 12 does not limit the scope of this disclosure to any particular implementation.

Referring to FIG. 12, an STA and an AP require D-SCS. The STA transmits, to the AP, a QoS Setup Request 1 frame for multiple QoS profiles including an indication for activation of QoS Profile-x. In response, the AP transmits, to the STA, a QoS Setup Response 1 frame for multiple QoS profiles and the AP activates the QoS Profile-x. Subsequently, the STA transmits, to the AP, a QoS Setup Request 2 frame for multiple QOS profiles including negotiation for new QoS parameters for any of the QoS profiles (proposing a modification to the QoS Profile Set). In response, the AP transmits, to the STA, a QoS Setup Response 2 frame for multiple QOS profiles indicating acceptance of the proposed modification to the QoS Profile Set.

In an embodiment, a first STA can transmit, to a second STA which the first STA has set up a D-SCS with, a QoS Profile Add request frame requesting to add a new QoS profile to the existing set of QoS profiles corresponding to the D-SCS flow. The first STA includes the QoS profile in the QoS Profile Add request frame that the first STA wants to add to the QoS profiles set. The second STA can transmit a QoS Profile Add Response frame to indicate acceptance or rejection.

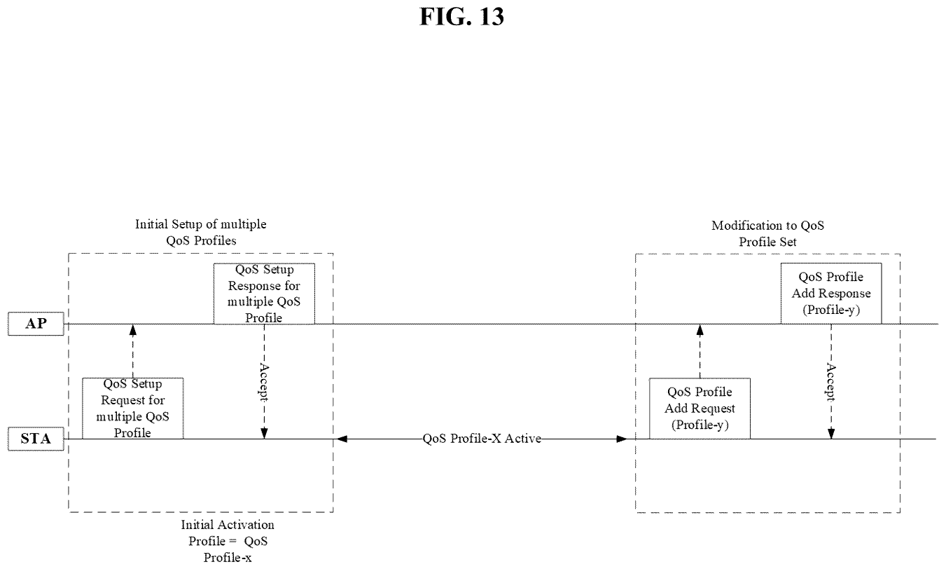

FIG. 13 shows another example QOS renegotiation in accordance with an embodiment. The renegotiation depicted in FIG. 13 is for explanatory and illustration purposes. FIG. 13 does not limit the scope of this disclosure to any particular implementation.

Referring to FIG. 13, an STA and an AP require D-SCS. The STA transmits, to the AP, a QoS Setup Request frame for multiple QOS profiles including an indication for activation of QoS Profile-x. In response, the AP transmits, to the STA, a QoS Setup Response frame for multiple QoS profiles and the AP activates the QoS Profile-x. Subsequently, the STA transmits, to the AP, a QoS Profile Add Request frame for a new QoS Profile-y (proposing a modification to the QoS Profile Set). In response, the AP transmits, to the STA, a QoS Profile Add Response, accepting the modification to the QoS Profile Set.

In an embodiment, a first STA can transmit, to a second STA which the first STA has set up a D-SCS with, a QoS Profile Delete Request frame that includes the QoS profile that the first STA wants to delete from the existing set of QoS profiles corresponding to the D-SCS flow. The second STA can transmit a QoS Profile Delete Response frame to indicate the acceptance or rejection of the QoS Profile Deletion request.

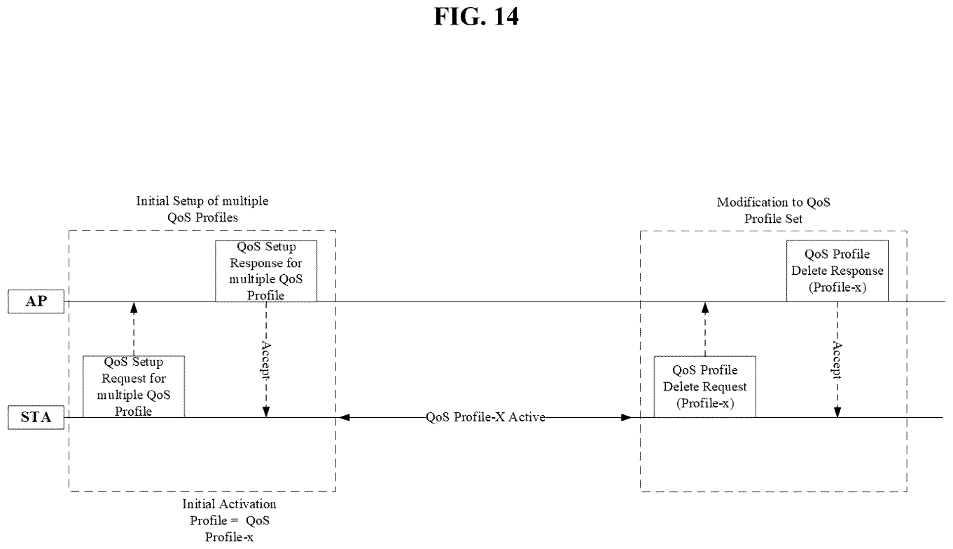

FIG. 14 shows another example QOS renegotiation in accordance with an embodiment. The renegotiation depicted in FIG. 14 is for explanatory and illustration purposes. FIG. 14 does not limit the scope of this disclosure to any particular implementation.

Referring to FIG. 14, an STA and an AP require D-SCS. The STA transmits, to the AP, a QoS Setup Request frame for multiple QOS profiles including an indication for activation of QoS Profile-x. In response, the AP transmits, to the STA, a QoS Setup Response frame for multiple QOS profiles and the AP activates the QoS Profile-x. Subsequently, the STA transmits, to the AP, a QoS Profile Delete Request frame for the QoS Profile-x requesting to delete the QoS Profile-x (proposing to modify the QoS Profile Set). In response, the AP transmits, to the STA, a QoS Profile Delete Response, accepting the modification to the QoS Profile Set.

In an embodiment, a first STA can transmit to a second STA which the first STA has set up a D-SCS with, a QoS Profile Add/Delete Request frame that includes an indication of a QoS profile that needs to be added, QoS Profile-y, and an indication of a QoS profile that needs to be deleted, QoS Profile-x. The second STA can transmit a QoS Profile Add/Delete Response frame to indicate an acceptance or a rejection or a modification request to the QoS Profile Add/Delete request.

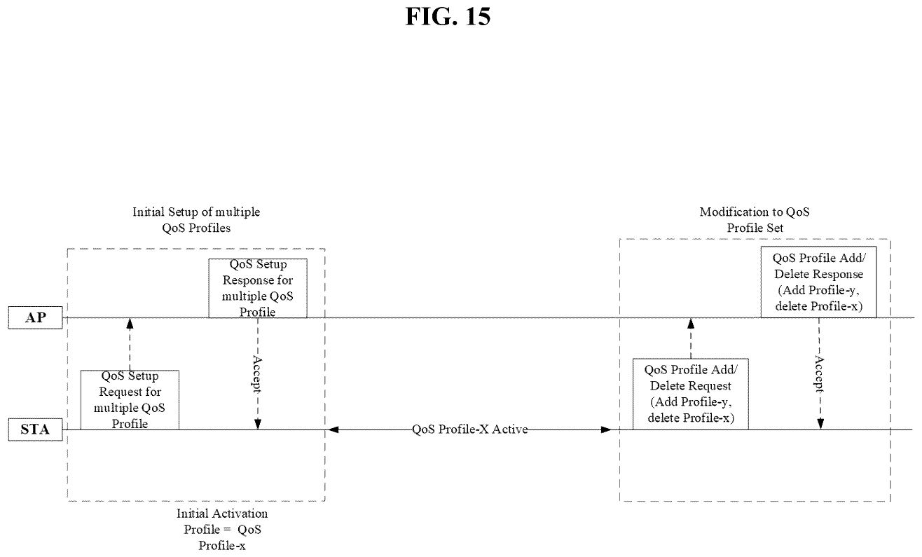

FIG. 15 shows another example QOS renegotiation in accordance with an embodiment. The renegotiation depicted in FIG. 15 is for explanatory and illustration purposes. FIG. 15 does not limit the scope of this disclosure to any particular implementation.

Referring to FIG. 15, an STA and an AP require D-SCS. The STA transmits, to the AP, a QoS Setup Request frame for multiple QOS profiles including an indication for activation of QoS Profile-x. In response, the AP transmits, to the STA, a QoS Setup Response frame for multiple QoS profiles and the AP activates the QoS Profile-x. Subsequently, the STA transmits, to the AP, a QoS Profile Add/Delete Request frame requesting to add QoS Profile-y and delete QoS Profile-x (proposing to modify the QoS Profile Set). In response, the AP transmits, to the STA, a QoS Profile Add/Delete Response, accepting the modification to the QoS Profile Set.

In an embodiment, a first STA can transmit, to a second STA which the first STA has set up an SCS with, a control frame indicating some change in the parameter of that SCS. In an embodiment, an A-Control field or any new control frame can be used for this purpose. Similarly, a management frame can also be used for this purpose. In an embodiment, the frame could include a list of parameter/value pairs (<parameter, value>). The parameter/value pairs list could indicate the SCS ID of the existing SCS setup for which the parameter change request applies. In an embodiment, the parameter list could include the parameters that are requested to be changed with the existing SCS setup identified by the SCS ID.

A possible format of the parameter/value pairs list to be included in the SCS Change Request is shown below in Table 1.

TABLE 1

| Changed SCS Parameters | Value |
|---|---|
| 0 (Minimum Service Interval) | X1 |
| 1 (Maximum Service Interval) | X2 |
| 2 (Minimum Data Rate) | X3 |
| 3 (Delay Bound) | X4 |
| 4 (Service Start Time) | X5 |
| 5 (Link ID) | X6 |
| 6 (Mean Data Rate) | X7 |
| 7 (MSDU Lifetime) | X8 |
| 8 (Medium Time) | X9 |
| 9 (User Priority) | X10 |
| 10 (TID) | X11 |

In an embodiment, if a first STA transmits, to a second STA which the first STA has set up an SCS with, an SCS request frame to modify any parameters of a first set of SCS parameters corresponding to the SCS, then the first STA can transmit, to the second STA, an SCS request frame indicating an SCS parameter change request. The SCS parameter change request can include a request to change a subset of the parameter's identified in the SCS ID resulting in a modified SCS set up characterized or parameterized by a second set of SCS parameters. If the second STA accepts the SCS parameter change request and transmits a response frame (e.g., an SCS Change response frame) indicating the acceptance of the SCS parameter change request, then upon transmission of the response frame, the second STA has established or implemented the second set of SCS parameters for the first STA.

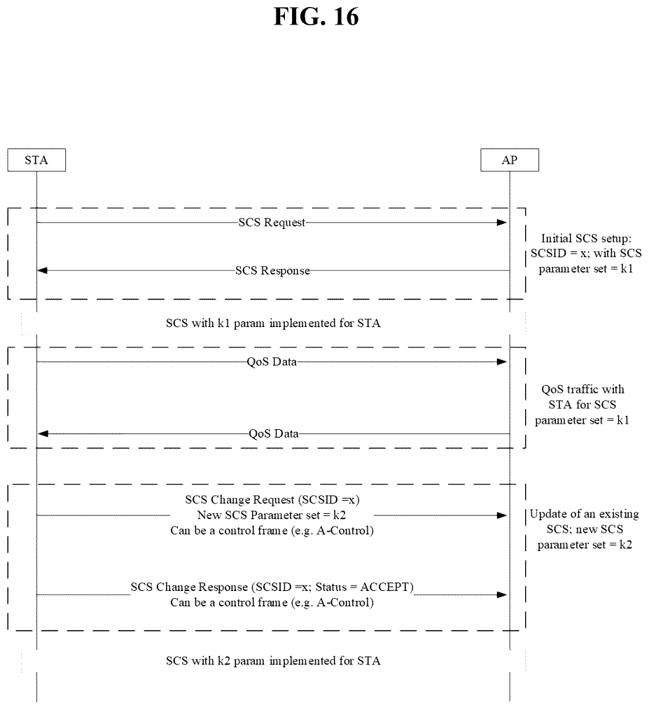

FIG. 16 shows an example SCS parameter set change request in accordance with an embodiment. The example depicted in FIG. 16 is for explanatory and illustration purposes. FIG. 16 does not limit the scope of this disclosure to any particular implementation.

Referring to FIG. 16, an STA and an AP require an SCS. The STA transmits, to the AP, an SCS request frame with an SCS ID of x and an SCS parameter set of k1. In response, the AP transmits, to the STA, an SCS response frame accepting the SCS request and implements, for the STA, the SCS with an SCS ID of x and an SCS parameter set k1. The STA and the AP transmit, to each other, QoS Data of their QoS traffic for the SCS parameter set k1. Subsequently, the STA transmits, to the AP, an SCS Change request frame indicating a request to change the SCS parameter set k1 to a new SCS parameter set k2. The SCS Change request frame may be a control frame (e.g., A-control frame). In response, the AP transmits, to the STA, an SCS Change response frame indicating that the AP accepts the SCS Change request and implements, for the STA, the SCS with parameter set k2. The SCS Change response frame may be a control frame (e.g., A-control frame).

In an embodiment, if a first STA transmits, to a second STA which the first STA has set up an SCS with, an SCS request frame to modify any parameters of a first set of SCS parameters corresponding to the SCS, then the first STA can transmit, to the second STA, an SCS request frame indicating an SCS parameter change request. The SCS parameter change request can include a request to change a subset of the parameter's identified in the SCS ID resulting in a modified SCS set up characterized or parameterized by a second set of SCS parameters. If the second STA intends to implement an alternate set of SCS parameters characterized by a third set of SCS parameters, then second STA can transmit an SCS response frame indicating that the second STA intends to implement an alternate set of SCS parameters, the third set of SCS parameters. Upon transmission of the response frame, the second STA establishes or implements the third set of SCS parameters for the first STA, wherein the new SCS setup corresponds to the third SCS parameter set. In an embodiment, in response to receiving the SCS response frame including the alternate set of SCS parameters, the first STA can transmit a new SCS change request frame including the third SCS parameter set suggested by the second STA. In response, the second STA can transmit a new response frame accepting the new SCS change request. Upon transmission of the new response frame accepting the new SCS change request, the second STA implements the third SCS parameter set for the first STA.

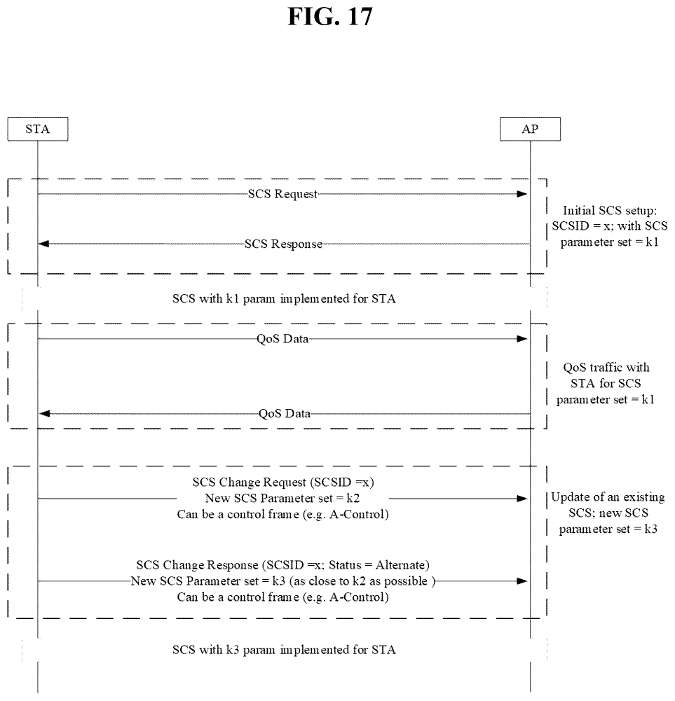

FIG. 17 shows another example SCS parameter set change request in accordance with an embodiment. The example depicted in FIG. 17 is for explanatory and illustration purposes. FIG. 17 does not limit the scope of this disclosure to any particular implementation.

Referring to FIG. 17, an STA and an AP require an SCS. The STA transmits, to the AP, an SCS request frame with an SCS ID of x and an SCS parameter set of k1. In response, the AP transmits, to the STA, an SCS response frame accepting the SCS request and implements, for the STA, the SCS with an SCS ID of x and an SCS parameter set k1. The STA and the AP transmit, to each other, QOS Data of their QoS traffic for the SCS parameter set k1. Subsequently, the STA transmits, to the AP, an SCS Change request frame indicating a request to change the SCS parameter set k1 to a new SCS parameter set k2. The SCS Change request frame may be a control frame (e.g., A-control frame). In response, the AP transmits, to the STA, an SCS Change response frame indicating that the AP intends to implement an alternate SCS parameter k3 and implements, for the STA, the SCS with the alternate SCS parameter set k3. The SCS Change response frame may be a control frame (e.g., A-control frame).

A Multi-AP (MAP) Coordination is considered as one of the key technologies for the next generation WLAN systems. In MAP coordination, several neighboring APs coordinate with each other for improved network performance.

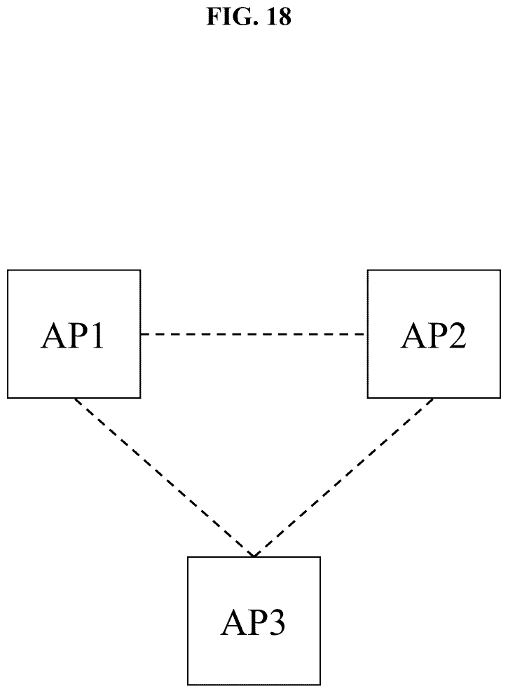

FIG. 18 shows an example of MAP coordination in accordance with an embodiment. The MAP coordination depicted in FIG. 18 is for explanatory and illustration purposes. FIG. 18 does not limit the scope of this disclosure to any particular implementation.

As shown in FIG. 4, the MAP coordination may be performed in a group of APs, for example, including AP1, AP2 and AP3. AP1, AP2 and AP3 may coordinate with each other in order to reduce latency resulting from natural overall throughput degradation and/or overlapping basic service set (OBSS) interference. As a result, AP1, AP2 and AP3 improve network performance through MAP coordination.

Coordinated Time Division Multiple Access (TDMA) or CTDMA is considered one of the important methods for MAP coordination. In this form of MAP coordination, a first AP, that has obtained a transmission opportunity (TXOP), can share a portion of its TXOP with a second AP participating in the MAP coordination set. In FIG. 4, for example, AP1, AP2 and AP3 can be members of the same MAP coordination set for CTDMA. AP1 can successfully contend for a TXOP and can share a first portion of its TXOP to AP2 and a second portion of its TXOP to AP3.

In the situation where two APs intend to participate in MAP coordination for performing CTDMA, how a determination is made regarding a time when the two APs will perform the CTDMA is unclear. A first AP may want to share a portion of its TXOP with a second AP, but the first AP may not know when the second AP needs the TXOP. Without the first AP knowing the needs of the second AP, the first AP can allocate a portion of the TXOP to the second AP when the second AP does not need the portion of the TXOP. Therefore, the TXOP allocated to the second AP might be wasted or might not be used by the second AP (the second AP shares the TXOP with an unintended STA).

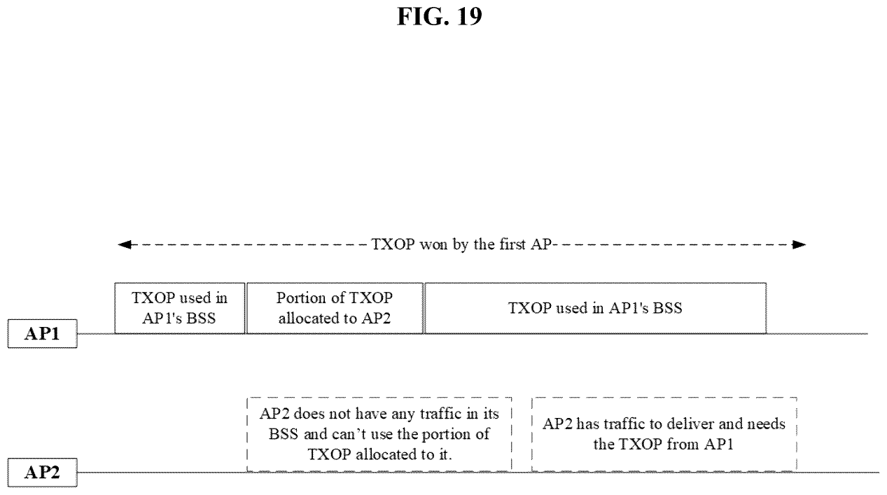

FIG. 19 shows an example need for MAP coordination in accordance with an embodiment. The example depicted in FIG. 19 is for explanatory and illustration purposes. FIG. 19 does not limit the scope of this disclosure to any particular implementation.

Referring to FIGS. 19, AP1 and AP2 are in MAP coordination performing CTDMA. AP1 obtains a TXOP after winning contention of the TXOP. AP1 uses its TXOP in AP1's BSS. Subsequently, AP1 allocates a portion of its TXOP to AP2. AP2, however, does not have any traffic in its BSS and cannot use the portion of the TXOP allocated to it. Subsequently, AP1 resumes using the TXOP in AP1's BSS. During AP1's use of the TXOP, AP2 now has traffic to deliver and needs a portion of the TXOP from AP1, but AP2 does not receive a portion of the TXOP for AP2's traffic.

In FIG. 19, the need is clear for some form of harmonization between the two APs prior to the sharing of TXOP so that both APs know the expectation on when the TXOP needs to be shared.

This disclosure introduces a framework for timing related harmonization among the APs participating in the MAP coordination and a concept of MAP coordination window.

In an embodiment, a first AP can negotiate with a second AP for MAP coordination. The mode of the MAP coordination can be CTDMA.

In an embodiment, when a first AP intends to perform MAP coordination with a second AP, the first AP can share, with the second AP, a set of timing-related information, which may indicate the time for MAP coordination between the two APs. The timing-related information can include the start time of MAP coordination and the end time of MAP coordination.

In an embodiment, a first AP can share with the second AP information related to a sequence to time windows when the first AP intends to perform MAP coordination with the second AP. The information related to a sequence to time windows may indicate the time periods during which the first AP intends to perform MAP coordination with the second AP. Such a time window can be referred to as a MAP coordination window (MAP CW), a MAP service period (MAP SP), a MAP coordination service period (MAPC SP) or any other related name. The information pertaining to a MAP CW may include a MAP CW start time, a MAP CW duration, a MAP CW interval and a MAP CW end time. The MAP CW start time indicates the time instance of the first CW or SP in a sequence of SPs for the MAP coordination. The MAP CW duration indicates the time duration of each of the CW or SP in a sequence of SPs for the MAP coordination. The MAP CW interval indicates the time interval between two consecutive CW or SPs. The MAP CW end time indicates the time when the MAP coordination window sequence will end.

In an embodiment, two APs that intend to participate in MAP coordination can share SCS-related information as part of the MAP coordination negotiation. For example, the two APs can exchange MAP CTDMA Request/Response frames as part of MAP CTDMA parameter negotiation between the two APs. A MAP CTDMA Request/Response frame may include a QoS Characteristics element to indicate the QOS related parameters for each of the APs that need to be assisted by the CTDMA. The MAP CTDMA Request/Response frame may also indicate the traffic pattern for the APs.

In an embodiment, the two APs that intend to participate in the MAP coordination can share MAP SP related information as part of the MAP coordination negotiation. For example, in a MAP CTDMA Request/Response frame, the MAP CTDMA Request/Response frame can include target wake time (TWT) parameters and negotiate on the TWT parameters.

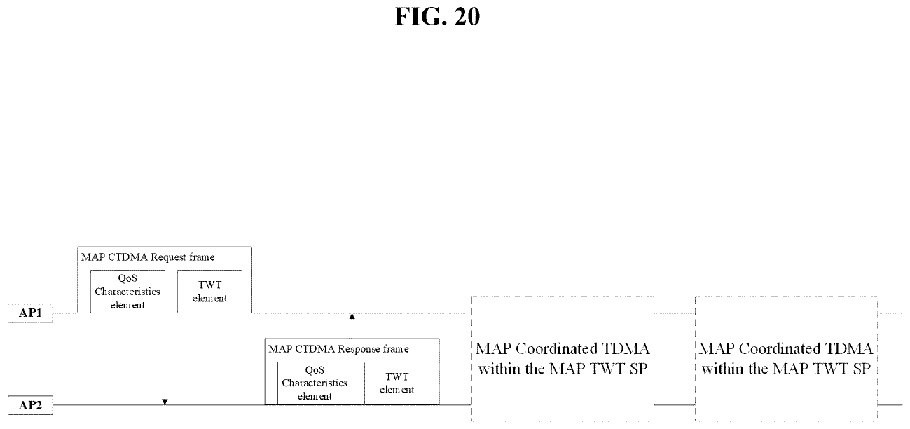

FIG. 20 shows an example CTDMA negotiation in accordance with an embodiment. The example depicted in FIG. 20 is for explanatory and illustration purposes. FIG. 20 does not limit the scope of this disclosure to any particular implementation.

Referring to FIGS. 20, AP1 and AP2 intend to participate in MAP coordination. AP1 transmits, to AP2, a MAP CTDMA Request frame including a QoS Characteristics element and a TWT element. In response, AP2 transmits, to AP1, a MAP CTDMA Response frame accepting the request. The MAP CTDMA Response frame includes a QoS Characteristics element and a TWT element. After transmission of the MAP CTDMA Response frame, AP1 and AP2 have finished MAP CTDMA negotiation and determined one or more MAP TWT SPs for MAP CTDMA. Subsequently, AP1 and AP2 perform MAP CTDMA within the one or more MAP TWT SPs.

Based on the negotiated TWT parameters, a sequence of MAP SPs can be established during which CTDMA can be performed.

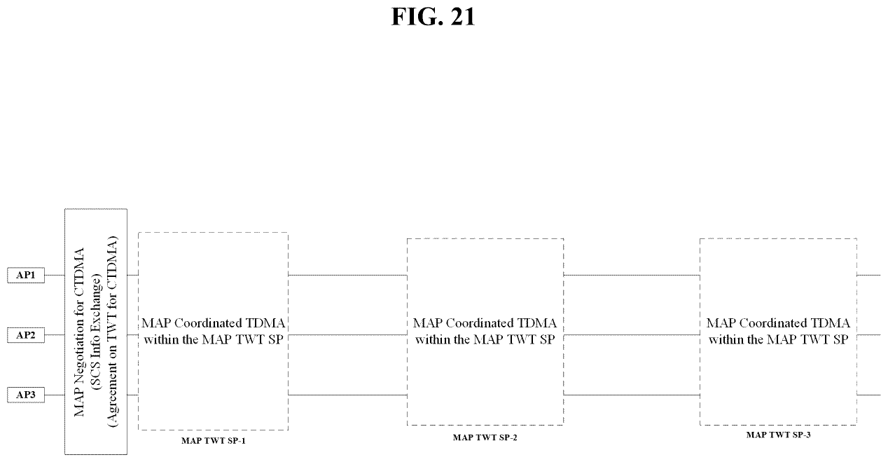

FIG. 21 shows an example MAP TWT SP based on CTDMA negotiation in accordance with an embodiment. The example depicted in FIG. 21 is for explanatory and illustration purposes. FIG. 21 does not limit the scope of this disclosure to any particular implementation.

Referring to FIGS. 21, AP1, AP2 and AP3 have concluded MAP negotiations for performing CTDMA. AP1, AP2 and AP3 exchanged SCS information during the MAP negotiations and agreed on TWT for the CTDMA. Subsequently, AP1, AP2 and AP3 perform CTDMA during MAP TWT SP-1, MAP TWT SP-2 and MAP TWT SP-3.

In an embodiment, after MAP CWs or MAP SPs are established or negotiated between APs participating in a CTDMA scheme, the AP that successfully contends for a TXOP can share a portion of the TXOP to another participating AP during a MAP SP. The AP that successfully contended for the TXOP can share another portion of the TXOP to a P2P group or P2P STA. The duration of the portion of the TXOP shared to the P2P group or P2P STA may go beyond the MAP SP duration.

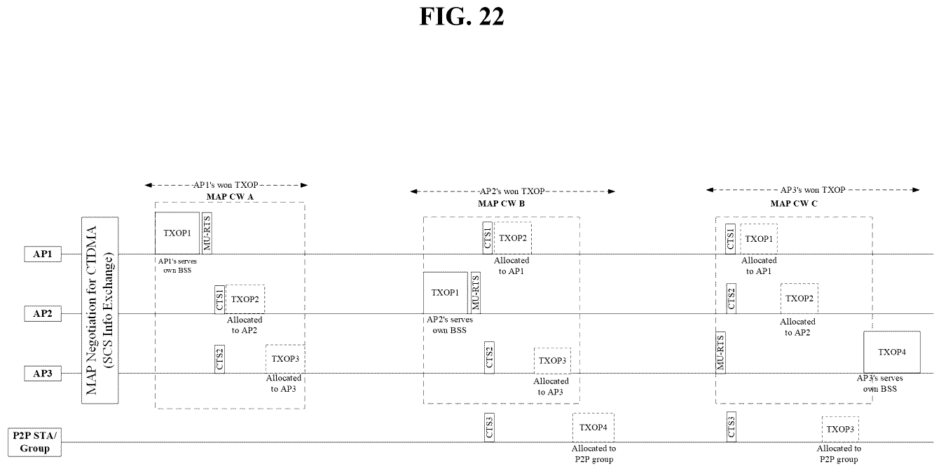

FIG. 22 shows an example TXOP sharing during MAP TWT SP in accordance with an embodiment. The example depicted in FIG. 22 is for explanatory and illustration purposes. FIG. 22 does not limit the scope of this disclosure to any particular implementation.

Referring to FIGS. 22, AP1, AP2 and AP3 have concluded MAP negotiations for performing CTDMA. AP2 and AP3 are associated with a P2P STA or P2P Group. AP1, AP2 and AP3 determined three MAP CWs, a MAP CW A, a MAP CW B and a MAP CW C. AP1 successfully contends for a TXOP during the MAP CW A. AP1 uses a portion of its TXOP to serve its own BSS. Subsequently, AP1 transmits, to AP2 and AP3, a multi-user (MU)-request to send (RTS) frame allocating a portion of AP1's TXOP to AP2 and a different portion of AP1's TXOP to AP3. In response, AP2 transmits, to AP1, a CTS1 frame and uses the portion of AP1's TXOP allocated to AP2. AP3 transmits, to AP1, a CTS2 frame and, after the portion of AP1's TXOP allocated to AP2, uses portion of AP1's TXOP allocated to AP3.

Subsequently, AP2 successfully contends for a TXOP during the MAP CW B. AP2 uses a portion of its TXOP to serve its own BSS. Subsequently, AP2 transmits, to AP1, AP3 and a P2P Group (or a P2P STA in the P2P Group), an MU-RTS frame allocating a portion of AP2's TXOP to AP1, a different portion of AP2's TXOP to AP3 and a different portion of AP2's TXOP to the P2P Group. In response, AP1 transmits, to AP2, a CTS1 frame and uses the portion of AP2's TXOP allocated to AP1. AP3 transmits, to AP2, a CTS2 frame and, after the portion of AP2's TXOP allocated to AP1, uses the portion of AP2's TXOP allocated to AP3. The P2P Group transmits, to AP2, a CTS3 frame and, after the portion of AP2's TXOP allocated to AP3, uses the portion of the AP2's TXOP allocated to the P2P Group which extends beyond the MAP CW B.

Subsequently, the AP3 successfully contends for a TXOP during the MAP CW C. Subsequently, the AP3 transmits, to AP1, AP2 and the P2P Group, an MU-RTS frame allocating a portion of the AP3's TXOP to the AP1, a different portion of the AP3's TXOP to the AP2 and a different portion of AP3's TXOP to the P2P Group. In response, AP1 transmits, to AP3, a CTS1 frame and uses the portion of AP3's TXOP allocated to AP1. AP2 transmits, to AP3, a CTS2 frame and, after the portion of AP3's TXOP allocated to AP1, uses the portion of AP3's TXOP allocated to AP2. The P2P Group transmits, to AP2, a CTS3 frame and, after the portion of AP3's TXOP allocated to AP2, uses the portion of AP3's TXOP allocated to the P2P Group. Subsequently, AP3 uses a portion of its TXOP to serve its own BSS, which extends beyond the MAP CW C.

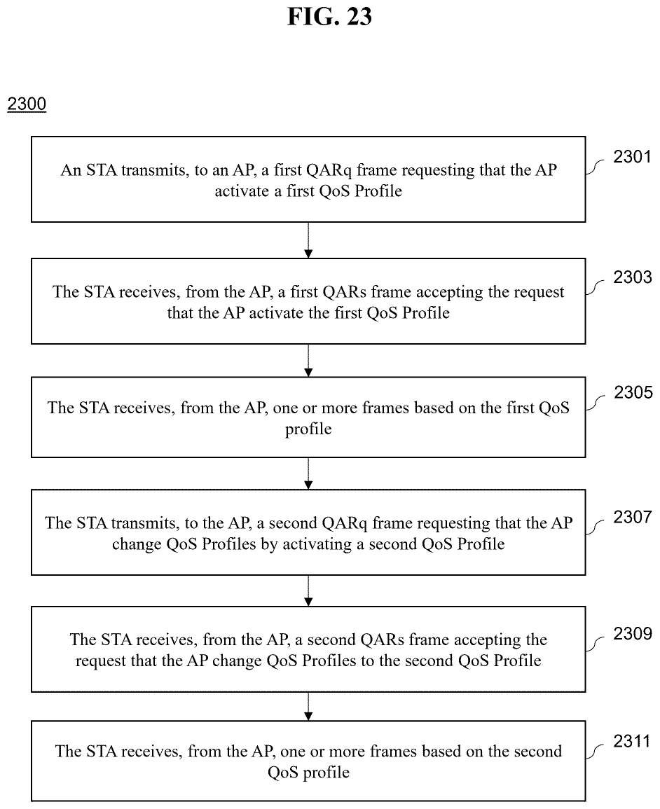

FIG. 23 shows an example process establishing a QoS setup in accordance with an embodiment. The process depicted in FIG. 23 is for explanatory and illustration purposes. FIG. 23 does not limit the scope of this disclosure to any particular implementation.

Referring to FIG. 23, the process 2300 begins at operation 2301. In operation 2301, an STA transmits, to an AP, a first QARq frame requesting that the AP activate a first QoS Profile. The STA transmits the first QARq frame after initial successful setup of a D-SCS with the AP. The D-SCS includes a plurality of QOS profiles. The first QoS Profile is a respective one QoS Profile of the plurality of QOS profiles. The QARq frame may instead be a QPI frame.

In operation 2303, the STA receives, from the AP, a first QARs frame accepting the request that the AP activate the first QoS Profile. If the STA transmitted a QPI frame, then the STA may receive an Ack frame.

In operation 2305, the STA receives, from the AP, one or more frames based on the first QoS profile.

In operation 2307, the STA transmits, to the AP, a second QARq frame requesting that the AP change QOS Profiles by activating a second QoS Profile. The second QoS Profile is a respective one QoS Profile of the plurality of QoS profiles. The QARq frame may instead be a QPI frame.

In operation 2309, the STA receives, from the AP, a second QARs frame accepting the request that the AP change QOS Profiles to the second QoS Profile. If the STA transmitted a QPI frame, then the STA may receive an Ack frame.

In operation 2311, the STA receives, from the AP, one or more frames based on the second QoS Profile.

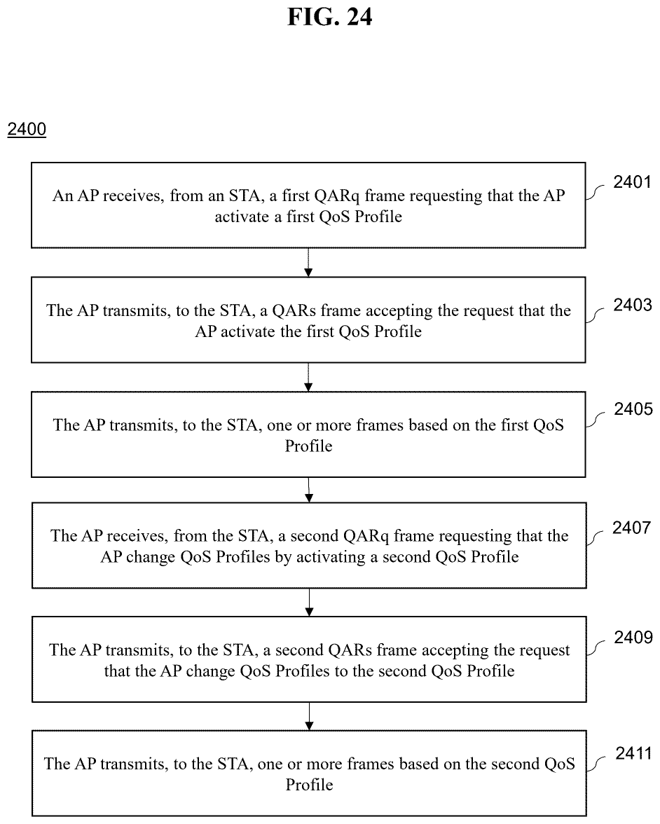

FIG. 24 shows another example process establishing a QoS setup in accordance with an embodiment. The process depicted in FIG. 24 is for explanatory and illustration purposes. FIG. 24 does not limit the scope of this disclosure to any particular implementation.

Referring to FIG. 24, the processor 2400 begins at operation 2401. In operation 2401, an AP receives, from an STA, a first QARq frame requesting that the AP activate a first QoS Profile. The AP receives the first QARq frame after initial successful setup of a D-SCS with the STA. The D-SCS includes a plurality of QoS profiles. The first QoS Profile is respective one QoS Profile of the plurality of QOS profiles. The QARq frame may instead be a QPI frame.

In operation 2403, the AP transmits, to the STA, a QARs frame accepting the request that the AP activate the first QoS Profile. If the AP received a QPI frame, then the AP may transmit an Ack frame.

In operation 2405, the AP transmits, to the STA, one or more frames based on the first QoS Profile. The AP transmits the one or more frames according to QoS flow requirements indicated by the first QoS Profile.

In operation 2407, the AP receives, from the STA, a second QARq frame requesting that the AP change QOS Profiles by activating a second QoS Profile. The QARq frame may instead be a QPI frame.

In operation 2409, the AP transmits, to the STA, a second QARs frame accepting the request that the AP change QoS Profiles to the second QoS Profile. If the AP received a QPI frame, then the AP may transmit an Ack frame.

In operation 2411, the AP transmits, to the STA, one or more frames based on the second QOS Profile. The AP transmits the one or more frames according to QoS flow requirements indicated by the second QoS Profile.

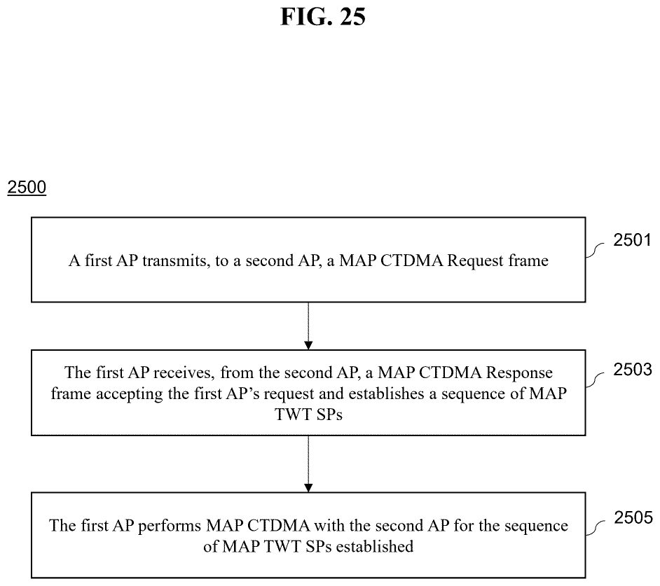

FIG. 25 shows an example process establishing MAP CTDMA in accordance with an embodiment. The process depicted in FIG. 25 is for explanatory and illustration purposes. FIG. 25 does not limit the scope of this disclosure to any particular implementation.

Referring to FIG. 25, the processor 2500 begins at operation 2501. In operation 2501, a first AP transmits, to a second AP, a MAP CTDMA Request frame. The MAP CTDMA Request frame may include a QOS Characteristics element and a TWT element.

In operation 2503, the first AP receives, from the second AP, a MAP CTDMA Response frame accepting the first AP's request and establishes a sequence of MAP TWT SPs. The MAP CTDMA Response frame may include a QOS Characteristics element and a TWT element.

In operation 2505, the first AP performs MAP CTDMA with the second AP for the sequence of MAP TWT SPs established.

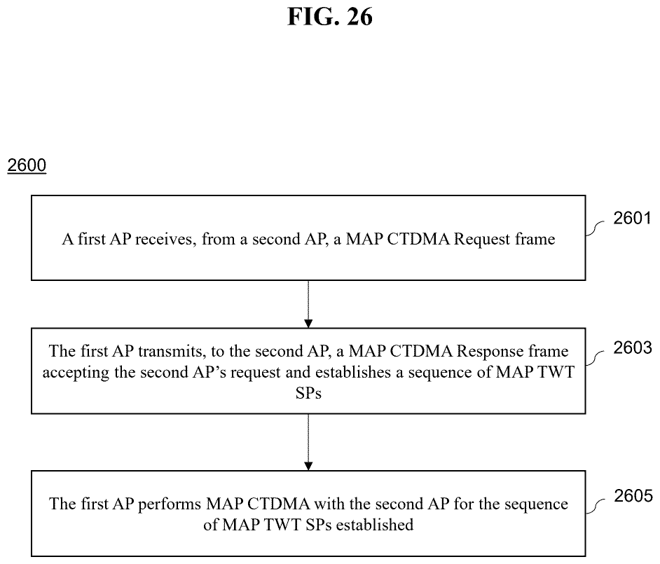

FIG. 26 shows another example process establishing MAP CTDMA in accordance with an embodiment. The process depicted in FIG. 26 is for explanatory and illustration purposes. FIG. 26 does not limit the scope of this disclosure to any particular implementation.

Referring to FIG. 26, the processor 2600 begins at operation 2601. In operation 2601, a first AP receives, from a second AP, a MAP CTDMA Request frame. The MAP CTDMA Request frame may include a QoS Characteristics element and a TWT element.

In operation 2603, the first AP transmits, to the second AP, a MAP CTDMA Response frame accepting the second AP's request and establishes a sequence of MAP TWT SPs. The MAP CTDMA Response frame may include a QoS Characteristics element and a TWT element.

In operation 2605, the first AP performs MAP CTDMA with the second AP for the sequence of MAP TWT SPs established.

The disclosure provides mechanisms and protocols for an STA or an AP to dynamically change a QoS flow with an associated AP in response to an unpredictable change in traffic pattern reducing unnecessary disruption for latency sensitive applications.

The various illustrative blocks, units, modules, components, methods, operations, instructions, items, and algorithms may be implemented or performed with processing circuitry.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the subject technology. The term “exemplary” is used to mean serving as an example or illustration. To the extent that the term “include,” “have,” “carry,” “contain,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, the description may provide illustrative examples and the various features may be grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The embodiments are provided solely as examples for understanding the invention. They are not intended and are not to be construed as limiting the scope of this invention in any manner. Although certain embodiments and examples have been provided, it will be apparent to those skilled in the art based on the disclosures herein that changes in the embodiments and examples shown may be made without departing from the scope of this invention.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. An access point (AP) for facilitating communication in a wireless network, comprising:
a memory; and
a processor coupled to the memory, the processor configured to cause:
receiving, from a station (STA), a first request frame requesting dynamic stream classification service, the first request frame including a plurality of quality of service (QOS) profiles, each QoS profile being associated with a respective QoS characteristics element indicating QoS expectation of traffic flow;
transmitting, to the STA, a first response frame accepting the request for dynamic stream classification service;
transmitting, to the STA, one or more frames based on a first QoS profile among the plurality of QOS profiles;
receiving, from the STA, a frame indicating a switch to a second QoS profile among the plurality of QOS profiles; and
transmitting, to the STA, one or more frames based on the second QoS profile in response to the frame indicating a switch to the second QoS profile.

2. The AP of claim 1, wherein the first response frame includes one or more QoS profiles, each QoS profile being associated with a respective QoS characteristics element indicating QoS expectation of traffic flow.

3. The AP of claim 1, wherein the processor is further configured to cause:
prior to transmitting the one or more frames based on a first QoS profile, receiving, from the STA, a frame indicating activation of the first QoS profile.

4. The AP of claim 1, wherein the first request frame indicates activation of the first QoS profile.

5. The AP of claim 1, wherein the processor is further configured to cause:
receiving, from the STA, a second request frame requesting modification of one or more parameters of at least one QoS profile among the plurality of QoS profiles; and
transmitting, to the STA, a second response frame accepting modification of at least one parameter.

6. The AP of claim 1, wherein the processor is further configured to cause:
receiving, from the STA, a second request frame requesting to amend a QoS profile by adding a QoS profile, deleting a QoS profile, or changing a QoS profile; and
transmitting, to the STA, a second response frame accepting the request to amend the QoS profile.

7. The AP of claim 1, wherein the processor is further configured to cause:
receiving, from the STA, a second request frame requesting a modification of at least one parameter of the dynamic stream classification service based on a first parameter list;
transmitting, to the STA, a second response frame indicating an acceptance of the requested modification; and
changing the at least one parameter of the dynamic stream classification service based on the first parameter list.

8. The AP of claim 1, wherein the processor is further configured to cause:
receiving, from the STA, a second request frame requesting a modification of at least one parameter of the dynamic stream classification service based on a first parameter list;
transmitting, to the STA, a second response frame indicating a modification of at least one parameter of the dynamic stream classification service based on a second parameter list, wherein the second parameter list differs from the first parameter list; and
changing the at least one parameter of the dynamic stream classification service based on the second parameter list.

9. A station (STA) for facilitating communication in a wireless network, comprising:
a memory; and
a processor coupled to the memory, the processor configured to cause:
transmitting, to an access point (AP), a first request frame requesting dynamic stream classification service, the first request frame including a plurality of quality of service (QOS) profiles, each QoS profile being associated with a respective QoS characteristics element indicating QoS expectation of traffic flow;
receiving, from the AP, a first response frame accepting the request for dynamic stream classification service;
receiving, from the AP, one or more frames based on a first QoS profile among the plurality of QOS profiles;
transmitting, to the AP, a frame indicating a switch to a second QoS profile among the plurality of QoS profiles; and
receiving, from the AP, one or more frames based on the second QoS profile.

10. The STA of claim 9, wherein the first response frame includes one or more QoS profiles, each QoS profile being associated with a respective QoS characteristics element indicating QoS expectation of traffic flow.

11. The STA of claim 9, wherein the processor is further configured to cause:
prior to receiving the one or more frames based on a first QoS profile, transmitting, to the AP, a frame indicating activation of the first QoS profile.

12. The STA of claim 9, wherein the first request frame indicates activation of the first QoS profile.

13. The STA of claim 9, wherein the processor is further configured to cause:
transmitting, to the AP, a second request frame requesting modification of one or more parameters of at least one QoS profile among the plurality of QoS profiles; and
receiving, from the AP, a second response frame accepting the modification of at least one parameter.

14. The STA of claim 9, wherein the processor is further configured to cause:
transmitting, to the AP, a second request frame requesting to amend a QoS profile by adding a QoS profile, deleting a QoS profile, or changing a QoS profile; and
receiving, from the AP, a second response frame accepting the request to amend the QoS profile.

15. The STA of claim 9, wherein the processor is further configured to cause:
transmitting, to the AP, a second request frame requesting a modification of at least one parameter of the dynamic stream classification service based on a first parameter list; and
receiving, from the AP, a second response frame indicating an acceptance of the requested modification.

16. The STA of claim 9, wherein the processor is further configured to cause:
transmitting, to the AP, a second request frame requesting a modification of at least one parameter of the dynamic stream classification service based on a first parameter list; and
receiving, from the AP, a second response frame indicating a modification of at least one parameter of the dynamic stream classification service based on a second parameter list, wherein the second parameter list differs from the first parameter list.

17. A method performed by an access point (AP), the method comprising:
receiving, from a station (STA), a first request frame requesting dynamic stream classification service, the first request frame including a plurality of quality of service (QOS) profiles, each QoS profile being associated with a respective QoS characteristics element indicating QoS expectation of traffic flow;
transmitting, to the STA, a first response frame accepting the request for dynamic stream classification service;
transmitting, to the STA, one or more frames based on a first QoS profile among the plurality of QoS profiles;
receiving, from the STA, a frame indicating a switch to a second QoS profile among the plurality of QoS profiles; and
transmitting, to the STA, one or more frames based on the second QoS profile in response to the frame indicating a switch to the second QoS profile.

18. The method of claim 17, wherein the first response frame includes one or more QoS profiles, each QoS profile being associated with a respective QoS characteristics element indicating QoS expectation of traffic flow.

19. The method of claim 17, further comprising:
prior to transmitting the one or more frames based on a first QoS profile, receiving, from the STA, a frame indicating activation of the first QoS profile.

20. The method of claim 17, further comprising:
receiving, from the STA, a second request frame requesting modification of one or more parameters of at least one QoS profile among the plurality of QoS profiles; and
transmitting, to the STA, a second response frame accepting the modification of at least one parameter.
